(19) United States
(12) Patent Application Publication
(10) Pub. No.: US 2012/0140151 A1
(43) Pub. Date: Jun. 7, 2012

(54) LIQUID CRYSTAL DISPLAY DEVICE AND MULTILAYER POLARIZATION PLATE

(75) Inventors: Tetsuo Yoshimura, Osaka (JP); Eiichiroh Nishimura, Osaka (JP)

(73) Assignee: SHARP KABUSHIKI KAISHA, Osaka (JP)

(21) Appl. No.: 13/321,033

(22) PCT Filed: Jan. 27, 2010
(86) PCT No.: PCT/JP2010/051015

§ 371 Date: Jan. 31, 2012

(30) Foreign Application Priority Data
May 18, 2009 (JP) 2009-119564

(51) Int. Cl. G02F 1/1335

(52) U.S. Cl. 349/96

(57) ABSTRACT

A liquid crystal panel 10, a multilayer polarization plate 20, and a cover member such as a touch panel 30, a cover glass, or the like are laminated in this order to form a liquid crystal display device 1. The multilayer polarization plate 20 and the liquid crystal panel 10 are attached together by an adhesive layer 24 formed on one surface of the multilayer polarization plate 20. The multilayer polarizing plate 20 and the cover member are attached together by an adhesive layer 26 formed on the other surface of the multilayer polarization plate 20. The adhesive layers 24 and 26 are respectively covered by separators 25 and 27.

### TECHNICAL FIELD

The present invention relates to a liquid crystal display device and to a multilayer polarization plate used in the liquid crystal display device.

### BACKGROUND ART

A liquid crystal panel that is used as a means of display is combined with other functional elements to constitute a liquid crystal module. Patent Document 1 shows an example of other functional elements. Patent Document 1 discloses a polarization plate, a retardation plate, and an elliptical polarization plate. These functional elements are formed by attaching a plurality of plates or films together with an adhesive layer.

In liquid crystal display devices that are used in small electronic devices, particularly those used in mobile phones, it is becoming more common to combine a liquid crystal module with a cover member, such as a touch panel, a cover glass, or the like. In order to attach a cover member to a liquid crystal module, traditionally, a double-sided adhesive tape has been used. However, there have been the following problems in this method. They are described with reference to FIGS. 5 to 7.

A liquid crystal module 100 shown in FIG. 5 is formed by attaching a polarization plate 102 to a liquid crystal panel 101. When a double-sided adhesive tape 103 is applied to a surface of the polarization plate 102 in order to attach a cover member to the liquid crystal module 100, there has been a problem of a foreign substance 104 entering between the polarization plate 102 and the double-sided adhesive tape 103. The foreign substance 104 obstructs transmission of light and causes display anomalies. In addition, when a protrusion is formed in the double-sided adhesive tape 103 by the foreign substance 104, refraction of light is disarrayed only at this location, also causing display anomalies.

FIG. 6 shows a state in which a cover member, in this case, a touch panel 105, is attached to the liquid crystal module 100 with the double-sided adhesive tape 103. The back surface side of the touch panel 105 is treated with various prints, such as prints of a wire 106 and a decoration 107, a print of power resistance inhibitor, and the like, for example, which form projected portions of approximately 5 μm to 15 μm in thickness. When the touch panel 105 is attached to the double-sided adhesive tape 103, the double-sided adhesive tape 103 cannot be closely attached to recesses and protrusions, such as the wire 106, the decoration 107, and the like, due to a physical property of a base material of the double-sided adhesive tape 103. As a result, a phenomenon in which air bubbles form occurs often. The air bubbles tend to enter a corner portion 108 formed between the touch panel 105 and the wire 106 or the decoration 107. When the air bubbles are present, refraction of light is disarrayed, causing display anomalies.

Examples shown in FIGS. 5 and 6 as the polarization panel 102 often have a multilayer structure as actual products. An example of a multilayer structure is shown in FIG. 7.

A multilayer polarization plate 102 shown in FIG. 7 includes a polarization plate 102a and a retardation plate 102b, which are attached together with an adhesive layer 102c. An adhesive layer 102d is provided on the bottom surface of the retardation plate 102c, and is covered by a separator (release paper) 102e. The top surface of the polarization plate 102a is covered by a protective film 102f. The separator 102e is peeled off from the multilayer polarization plate 102, and the rest of the multilayer polarization plate 102 is attached to a liquid crystal panel 101 to form a liquid crystal module. If this liquid crystal module is attached to a touch panel 105 with a double-sided adhesive tape 103, occurrence of the problems described in FIGS. 5 and 6 cannot be avoided.

### RELATED ART DOCUMENTS

### Patent Documents

Patent Document 1: Japanese Patent Application Laid-Open Publication No. H6-51122

### SUMMARY OF THE INVENTION

### Problems to be Solved by the Invention

The present invention seeks to address the aforementioned problems, and has an object of obtaining a liquid crystal display device having an excellent display quality by not using a double-sided adhesive tape for attaching a cover member to a liquid crystal module in order to avoid entering of a foreign substance and formation of air bubbles caused by the double-sided adhesive tape.

### Means for Solving the Problems

In order to achieve the aforementioned object, the present invention is a liquid crystal display device, wherein the liquid crystal display device is formed by laminating a liquid crystal panel, a multilayer polarization plate, and a cover member in this order, and wherein the multilayer polarization plate and the liquid crystal panel are attached together by an adhesive layer formed on one surface of the multilayer polarization plate, and the multilayer polarization plate and the cover member are attached together by an adhesive layer formed on the other surface of the multilayer polarization plate.

According to this configuration, the cover member is directly attached to the adhesive layer of the multilayer polarization plate. Therefore, the risk of fine particles entering due to the double-sided adhesive tape interposed between the multilayer polarization plate and the cover member can be reduced, thereby preventing entering of a foreign substance. In addition, man-hour for attachment with the double-sided adhesive tape can be reduced.

In a liquid crystal display device having the aforementioned configuration, the cover member preferably is a touch panel or a cover glass.

According to this configuration, when observing a liquid crystal display through a touch panel or a cover glass, a screen having fewer display anomalies can be observed.

Furthermore, the present invention is a multilayer polarization plate that is used in a liquid crystal display device of the aforementioned configuration, wherein adhesive layers on both surfaces of the multilayer polarization plate are respectively covered by a separator.

According to this configuration, the adhesive layers do not attach to other objects unless the separator is peeled off, facilitating handling of the multilayer polarization plate.

In a multilayer polarization plate of the aforementioned configuration, the adhesive layer for attaching the cover member preferably has a thickness that can absorb a recess and a protrusion on a back surface of the cover member.

According to this configuration, a gap between a recess and a protrusion on the back surface of the cover member can be filled with the adhesive layer, preventing air bubbles from entering the gap.

### Effects of the Invention

According to the present invention, the risk of fine particles entering due to the double-sided adhesive tape interposed between the multilayer polarization plate and the cover member is reduced by adopting a configuration in which the cover member is directly attached to the adhesive layer provided on the multilayer polarization plate, thereby preventing entering of a foreign substance and reducing man-hour for attachment with the double-sided adhesive tape.

### BRIEF DESCRIPTION OF THE DRAWINGS

FIG. 1 is a schematic vertical cross-sectional view of a liquid crystal display device according to an embodiment of the present invention, showing a pre-assembly state.

FIG. 2 is a schematic vertical cross-sectional view of the liquid crystal display device according to an embodiment of the present invention, showing a state during assembly.

FIG. 3 is a schematic vertical cross-sectional view of the liquid crystal display device according to an embodiment of the present invention, showing another state during assembly.

FIG. 4 is a schematic vertical cross-sectional view of the liquid crystal display device according to an embodiment of the present invention, showing a post-assembly state.

FIG. 5 is a schematic vertical cross-sectional view for explaining a problem when a liquid crystal module is combined with a double-sided adhesive tape.

FIG. 6 is a schematic vertical cross-sectional view for explaining a different problem when a liquid crystal module is combined with a double-sided adhesive tape.

FIG. 7 is a schematic vertical cross-sectional view showing a configuration example of a conventional liquid crystal module.

### DETAILED DESCRIPTION OF EMBODIMENTS

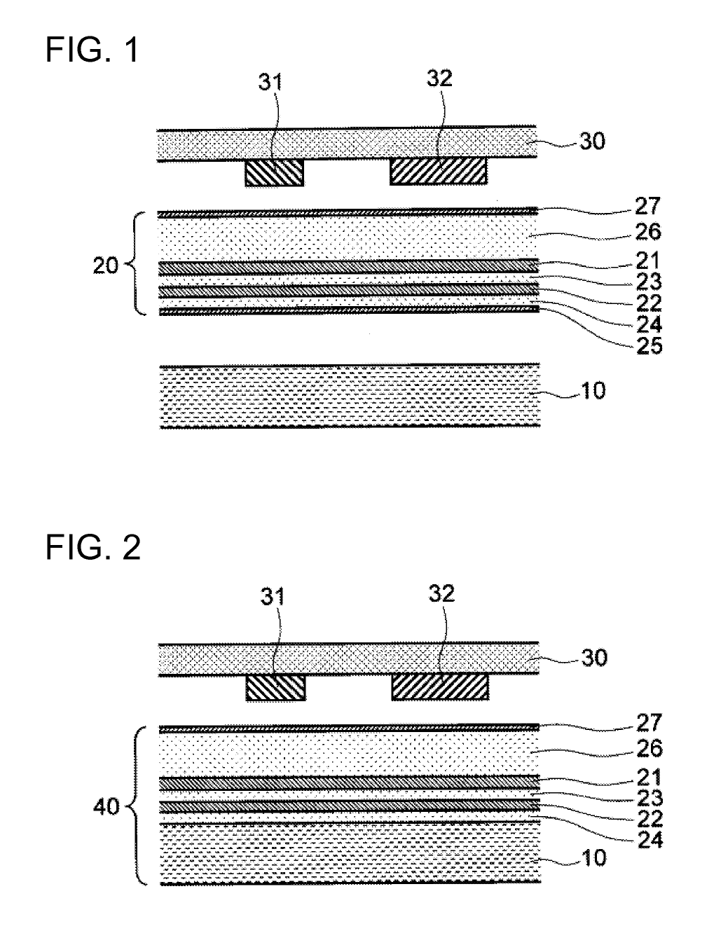

An embodiment according to the present invention is described below with reference to figures FIGS. 1 to 4.

A liquid crystal display device according to the present invention is formed by laminating a liquid crystal panel 10, a multilayer polarization plate 20, and a cover member in this order from the bottom. Here, a touch panel 30 is illustrated as a cover member. The back surface of the touch panel 30 is treated with various prints, such as prints of a wire 31 and a decoration 32, a print of power resistance inhibitor, and the like, for example, which form protrusions of approximately 5 μm to 15 μm in thickness.

The important point of the present invention is the multilayer polarization plate 20. The multilayer polarization plate 20 may include one or several of various functions such as wide viewing angle, retardation function, low reflection function, and the like. The multilayer polarization plate 20 includes a polarization plate 21 and a retardation plate 22, which are attached together by an adhesive layer 23. The bottom surface of the retardation plate 23 is provided with an adhesive layer 24, which is covered by a separator 25. The top surface of the polarization plate 21 is also provided with an adhesive layer 26, which is covered by a separator 27.

For the adhesive layer 26, a material whose thickness and hardness can be controlled with ease, such as acrylic, rubber, urethane material, or the like, is used. In addition, the adhesive layer 26 is made thick enough to absorb the thickness of a projected portion on the back surface of the cover member (touch panel 30 in this case). If the thickness of the projected portion is approximately 5 μm to 15 μm, the thickness of the adhesive layer 26 preferably is 50 μm or more.

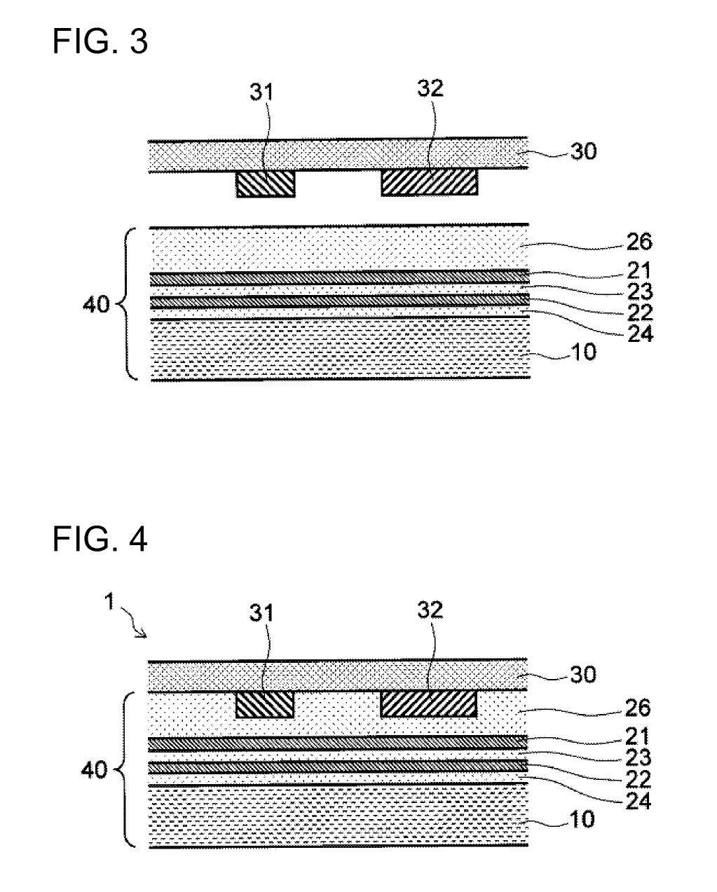

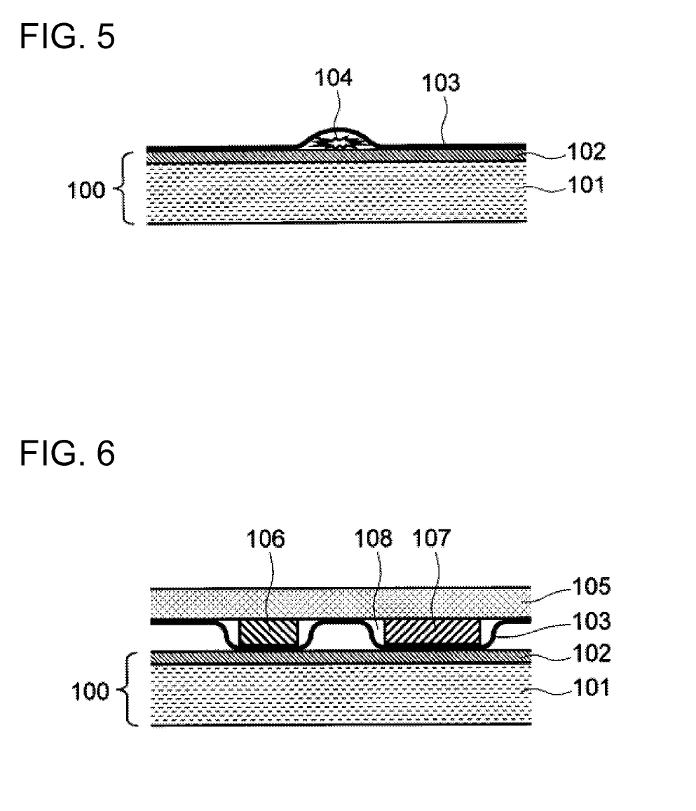

The separator 25 is peeled off from the multilayer polarization plate 20, and the rest is attached to the liquid crystal panel 10. This way, a liquid crystal module 40 shown in FIG. 2 is formed. The separator 27 is peeled off from this liquid crystal module 40 to obtain a state shown in FIG. 3. The touch panel 30 is pressed and attached onto the liquid crystal module 40 in this state to complete a liquid crystal display device 1 shown in FIG. 4.

In the liquid crystal display device 1 shown in FIG. 4, recesses and protrusions on the back surface of the touch panel 30 are filled with the adhesive layer 26, and air bubbles do not form. The relation between the thickness of projected portions and the thickness of the adhesive layer 26 is as described above; however, it is preferable to carefully select the hardness of the adhesive layer 26 so that the adhesive layer 26 can closely follow the contour of the recessed and projected pattern.

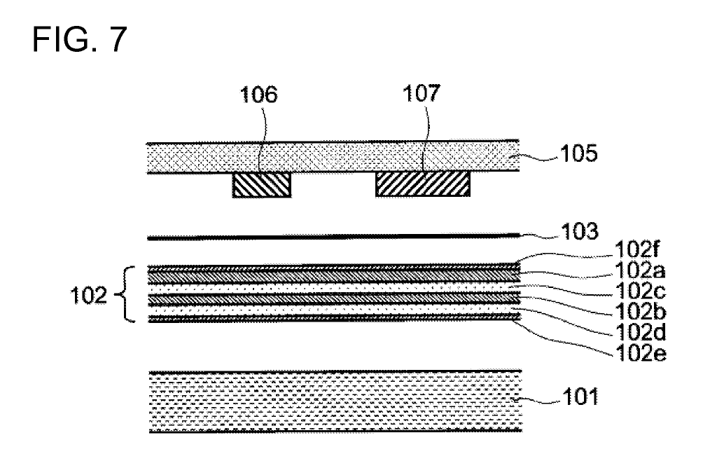

According to the configuration of the aforementioned embodiment, the touch panel 30 is attached directly to the adhesive layer 26 of the multilayer polarization plate 20. Therefore, the risk of fine particles entering due to a double-sided adhesive tape interposed between the polarization plate 20 and the touch panel 30 is reduced, and entering of a foreign substance can be prevented. Furthermore, man-hour for attachment using a double-sided adhesive tape can be reduced. Formation of air bubbles due to a base member of the double-sided adhesive tape not being able to closely follow the contour of recesses and protrusions can be also prevented. In addition, the polarization plate 21, which is the core of the multilayer polarization plate 20, is protected by the adhesive layer 26. Therefore, a hard coating treatment of the surface of the polarization plate or a protective film (shown in FIG. 7), which has been necessary traditionally, becomes no longer necessary. As a result, costs of such treatments can be reduced.

An embodiment of the present invention was described above. However, the scope of the present invention is not limited to such, and the present invention can be implemented with various modifications added without departing from the spirit of the invention.

### INDUSTRIAL APPLICABILITY

The present invention can be widely used in a liquid crystal display device in which a cover member such as a touch panel, a cover glass, or the like is attached to a liquid crystal module.

### DESCRIPTION OF REFERENCE CHARACTERS

1 liquid crystal display device

10 liquid crystal panel

20 multilayer polarization plate

21 polarization plate

22 retardation plate

23, 24, 26 adhesive layers

25, 27 separators

30 touch panel

31 wire

32 decoration

40 liquid crystal module

1. A liquid crystal display device, wherein said liquid crystal display device is formed by laminating a liquid crystal panel, a multilayer polarization plate, and a cover member in this order, and
wherein said multilayer polarization plate and said liquid crystal panel are attached together by an adhesive layer formed on one surface of said multilayer polarization plate, and said multilayer polarization plate and said cover member are attached together by an adhesive layer formed on the other surface of said multilayer polarization plate.

2. The liquid crystal display device according to claim 1, wherein said cover member is either a touch panel or a cover glass.

3. A multilayer polarization plate used in the liquid crystal display device according to claim 1, wherein the adhesive layers on both surfaces of said multilayer polarization plate are respectively covered by a separator.

4. The multilayer polarization plate according to claim 3, wherein said adhesive layer for attaching said cover member has a thickness that can absorb a recess and a protrusion on a back surface of said cover member.

5. A method for manufacturing a liquid crystal display device, comprising
attaching a multilayer polarization plate to a liquid crystal panel through an adhesive layer pre-formed on one surface of said multilayer polarization plate; and
attaching a cover member to said multiplayer polarization plate by an adhesive layer pre-formed on the other surface of said multilayer polarization plate.

6. The method according to claim 5, wherein said cover member is either a touch panel or a cover glass.

7. The method according to claim 5, further comprising:
removing a separator provided on the adhesive layer preformed on the one surface of said multiplayer polarization plate to expose said adhesive layer before the step of attaching the multilayer polarization plate; and
removing a separator provided on the adhesive layer preformed on the other surface of said multilayer polarization plate to expose said adhesive layer before step of attaching the cover member.

8. The method according to claim 5, wherein said adhesive layer on the other surface of said multilayer polarization plate for attaching said cover member has a thickness that can absorb a recess and a protrusion on a back surface of said cover member so that the step of attaching the cover member causes the recess and the protrusion on the back surface of said cover member to be immersed in said adhesive layer on the other surface of said multilayer polarization plate.
